(19) United States
(12) Patent Application Publication
(10) Pub. No.: US 2018/0222000 A1
(43) Pub. Date: Aug. 9, 2018

(54) FRICTION SPOT SEALING OF A DEFECT AREA IN A WORKPIECE

(71) Applicant: GE-Hitachi Nuclear Energy Americas LLC, Wilmington, NC (US)

(72) Inventor: Henry Peter OFFER, San Jose, CA (US)

(73) Assignee: GE-Hitachi Nuclear Energy Americas LLC, Wilmington, NC (US)

(21) Appl. No.: 15/423,899

(22) Filed: Feb. 3, 2017

(51) Int. Cl. B23P 6/04; B23K 20/12; B23K 20/26; G21C 19/20

(52) U.S. Cl. CPC B23P 6/04; B23K 20/129; B23K 20/121; G21Y 2004/50; B23K 20/26; G21C 19/207; B23K 20/1215

(57) ABSTRACT

A method for reducing leakage through a defect area of a reactor component (or other workpiece), apparatus for performing the method, and product formed therefrom are disclosed. The method includes forming first and second spot material portions on the reactor component by friction-sealing first and second parts of a consumable structure to first and second positions of the reactor component. The friction-sealing includes pressing the consumable structure against the first and second positions of the reactor component while using a machine to rotate and/or oscillate the consumable structure, and moving the consumable structure away from the reactor component in between the forming the first and second spot material portions. The first and second positions of the reactor component are different and include a portion of the defect area. At least one of the first and second spot material portions overlaps the portion of the defect area.

### BACKGROUND

### Field

The present disclosure relates to a friction-spot sealing method for reducing leakage through a defect area of workpiece (e.g., reactor component), an apparatus for performing the friction-spot sealing method, and/or a product including a bridge formed using the friction-spot sealing method to cover a defect area of a workpiece.

### Description of Related Art

Some structures that are typically submerged under a fluid, separate portions of a fluid, or contain a pressurized fluid, may develop defect areas. Fluid may leak through the defect areas causing loss of fluid volume or pressure, or contamination by the leaking fluid. For example, commercial nuclear power plants may have internal reactor components that contain defect areas such as cracks, openings, and gaps, and/or regions that include several defect areas. In nuclear reactors, core shrouds, steam pipes, and the like may contain through-thickness cracks caused by various Stress Corrosion Cracking (SCC) and fatigue cracking mechanisms. During operation, fluid may leak through the defects area(s) of the reactor components due to a differential pressure across the defect area(s). The fluid leakage may present operational and regulatory issues.

A reactor component that includes defect area(s) may be highly activated and contaminated so draining the reactor fluid (e.g., core water) to perform general repairs may be impractical. Also, replacing reactor components may be costly. Accordingly, processes for repairing the defects area(s) and/or region(s) of reactor components without draining the reactor fluid of the reactor or without the need for repair personnel direct access are being investigated.

### SUMMARY

According to an example embodiment, a method for reducing (and/or eliminating) leakage through a defect area defined in a reactor component is provided. The method includes forming a first spot material portion on the reactor component by friction-sealing a first part of a consumable structure to the reactor component at a first position of the reactor component, moving the consumable structure away from the reactor component to face a second position of the reactor component, and forming a second spot material portion on the reactor component by friction-sealing a second part of the consumable structure to the reactor component at the second position of the reactor component. The friction-sealing the first part includes pressing the consumable structure against the first position of the reactor component while using a machine to at least one of rotate and oscillate the consumable structure. The friction-sealing the second part includes pressing the consumable structure against the second position of the reactor component while using the machine to at least one of rotate and oscillate the consumable structure. The first and second positions of the reactor component are different positions and include a portion of the defect area. At least one of the first and second spot material portions overlaps the portion of the defect area.

At least one of the spot material portions may overlap a previously deposited spot material portion to progressively affect a final seal condition.

According to an example embodiment, an apparatus for reducing leakage through a defect area defined in a reactor component is provided. The apparatus includes a motor, a coupling structure, a driver, and a controller. The motor is configured to at least one of rotate and oscillate a consumable structure including at least one metal. The coupling structure is configured to couple the consumable structure to the motor. The driver is configured to press the consumable structure against different locations of the reactor component while the consumable structure is at least one of rotating and oscillating. The driver is configured to retract the consumable structure away from reactor component and to reposition the consumable structure to face the different locations of the reactor component. The controller is configured to control the motor, and the driver to form a bridge (e.g., sealing bridge) including a plurality of spot material portions on the reactor component without using a fusion welding process. Each one of the plurality of spot material portions overlaps at least one other spot material portion among the plurality of spot material portions.

According to an example embodiment, a product includes a workpiece defining a defect area and a bridge bonded to the workpiece at the defect area. The bridge includes a plurality of spot material portions. Each one of the plurality of spot material portions overlaps at least one other spot material portion among the plurality of spot material portions.

According to an example embodiment, a friction-spot bonding method is provided for reducing leakage through a defect area defined in a workpiece. The method includes using a machine that is coupled to a consumable structure to at least one of rotate and oscillate the consumable structure, and forming a plurality of spot material portions bonded to a plurality of positions of the workpiece. The forming the plurality of spot material portions includes forming a first spot material portion on the workpiece by moving the consumable structure to contact a first position of the workpiece for a first period of time while applying a first axial force to the consumable structure and using the machine to at least one of rotate the consumable structure at a first rotational speed and oscillate the consumable structure at a first frequency so a first part of the consumable structure heats and bonds to the first position of the workpiece, moving a remaining portion of the consumable structure away from the first position of the workpiece to face a second position of the workpiece, and forming a second spot material portion on the workpiece by moving the remaining portion of the consumable structure to contact the second position of the workpiece for a second period of time while applying a second axial force to the remaining portion of the consumable structure and using the machine to at least one of rotate the remaining portion of the consumable structure at a second rotational speed and oscillate the consumable structure at a second frequency so a second part of the consumable structure bonds and seals to the second position of the workpiece. The first and second positions of the workpiece are different positions and include a portion of the defect area. At least one of the first and second spot material portions overlaps at least part of the defect area.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 illustrates an example of a nuclear reactor pressure vessel assembly;

FIGS. 2A to 2B illustrate apparatuses for performing friction-spot sealing according to some example embodiments;

FIGS. 2C to 2E illustrate rotational movement, rotational oscillation, and linear oscillation of a consumable structure using friction-spot sealing apparatuses according to some example embodiments;

FIGS. 2F and 2G illustrate adjusting a lateral tilt angle of consumable structure using friction-spot sealing apparatuses according to some example embodiments;

FIGS. 3A, 3C, 3E, and 3G illustrate a gap defect area, a crack defect area, a region including a defect area, and an opening defect area in workpieces according to some example embodiments;

FIGS. 3B, 3D, 3F, 3H illustrate the workpieces in FIGS. 3A, 3C, 3E, and 3G, respectively, after being treated using various friction-spot sealing methods according to some example embodiments;

FIG. 4 is a flow chart illustrating operations of a friction-spot sealing method according to an example embodiment; and

FIGS. 5A and SC are examples of spot material portion patterns formed using friction-sealing methods according to some example embodiments. FIG. 5B illustrates the workpiece including the spot material portion pattern in FIG. 5A after a wet polishing process was performed.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. In the drawings, like reference numerals in the drawings denote like elements, and thus their description may be omitted.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

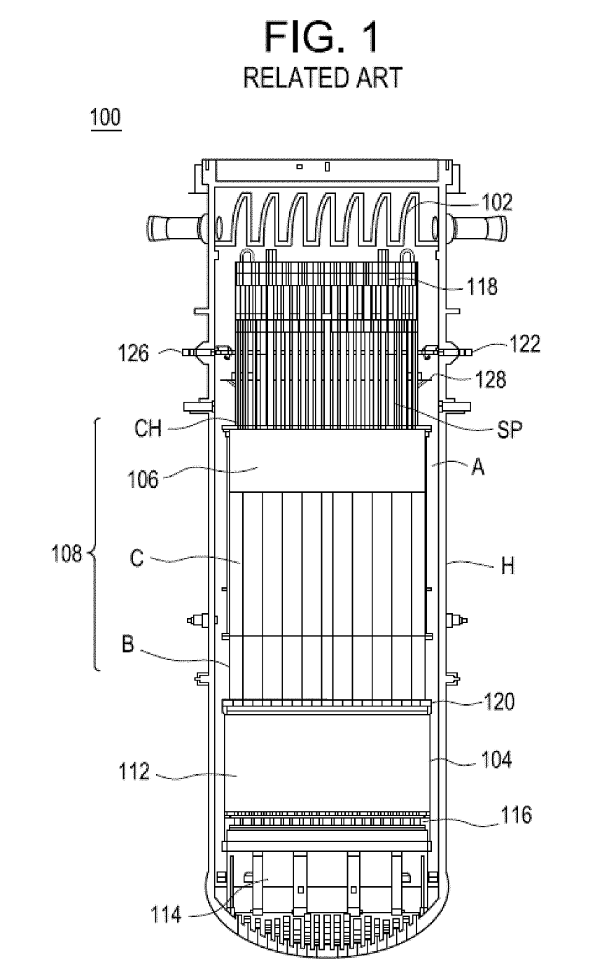

FIG. 1 illustrates an example of a nuclear reactor pressure vessel assembly. A nuclear reactor pressure vessel assembly is described in U.S. patent application Ser. No. 14/577,364 (filed on Dec. 19, 2014) and U.S. application Ser. No. 14/751,690 (filed on Jun. 26, 2015). The entire contents of aforementioned applications are incorporated herein in by reference.

Referring to FIG. 1, the nuclear reactor pressure vessel assembly 100 may include a housing H that surrounds a core inlet region 114, a shroud 104, a reactor core 112, a chimney assembly 108, and steam separators 118. Although not shown, a top head may be connected to a top of the housing H. The housing H may be the vertical wall of the reactor pressure vessel assembly 100. The reactor core 112 is over the core inlet region 114. The chimney assembly 108 is between the steam separators 118 and the reactor core 112. The steam separators 118 are over the chimney assembly 108. The reactor core 112 may be defined by an inner surface of the shroud 104, a core plate 116 secured to a bottom of the shroud 104, and a top guide 120 secured to a top of the shroud 104. The shroud 104 may be a hollow cylindrical structure that separates the reactor core 112 from the downcomer annulus flow in the annulus A. The core plate 116 may support control rods and fuel assemblies that include a plurality of fuel rods in the reactor core 112.

The chimney assembly 108 includes a chimney barrel B, chimney partitions C, a chimney head CH, and a plenum 106. An inner surface of the chimney barrel B defines a space between the reactor core 112 and the steam separators 118. Chimney partitions C divide the space defined by the inner surface of the chimney barrel B into smaller sections.

The annulus A is a space between the housing H and outer surfaces of the chimney assembly 108 and reactor core 112. Together, an inner surface of the chimney assembly 108 and an inner surface of the reactor core 112 define a conduit for transporting a gas-liquid two phase flow stream from the reactor core 112 through the chimney assembly 108 to the steam separators 118.

A steam dryer 102 may be connected on top of the steam separators 118. Steam separation occurs as the gas-liquid two phase flow stream enters the steam separators 118. The reactor pressure vessel assembly 100 includes at least one feedwater sparger 126 in the housing H that is configured to deliver a subcooled feedwater into the annulus A. A feedwater nozzle 122 may be connected to each feedwater sparger 126 through the feedwater opening defined in the housing H. A support plate 128 may be secured to the chimney head CH.

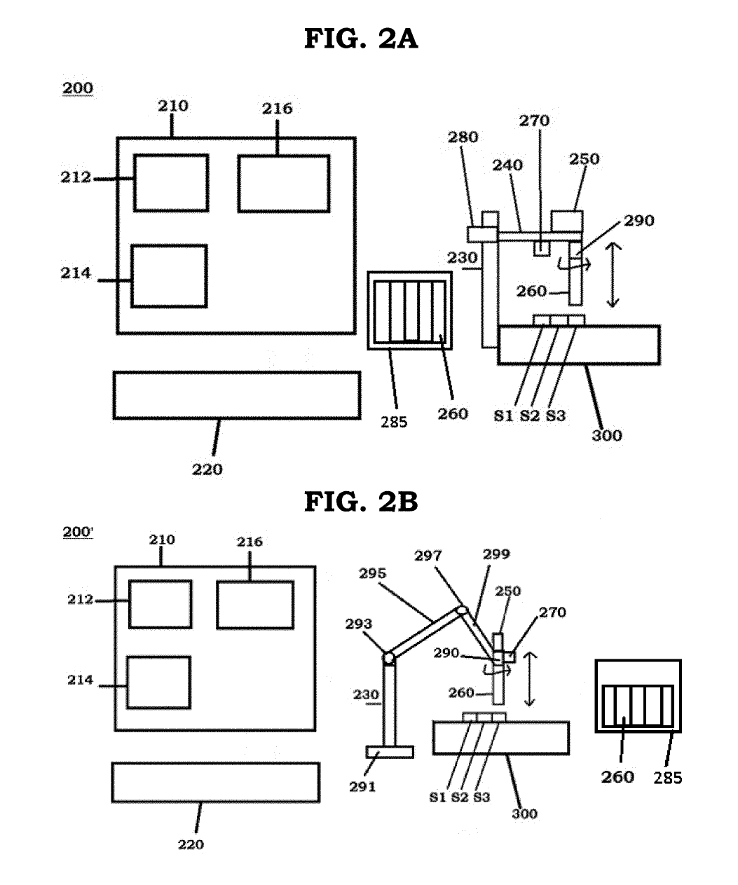

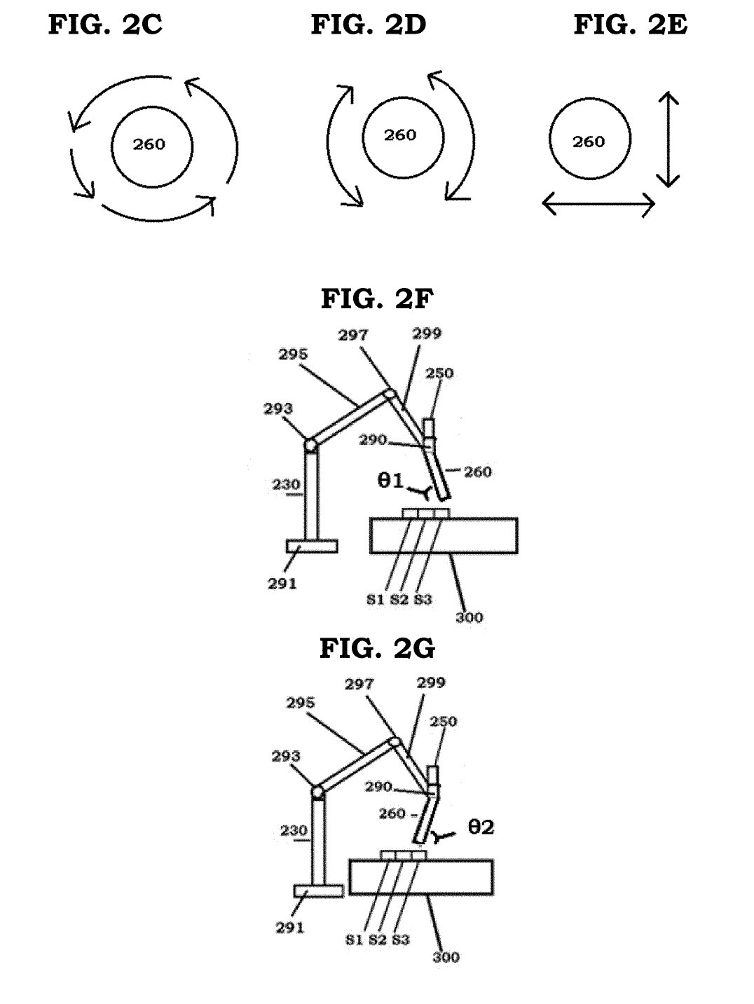

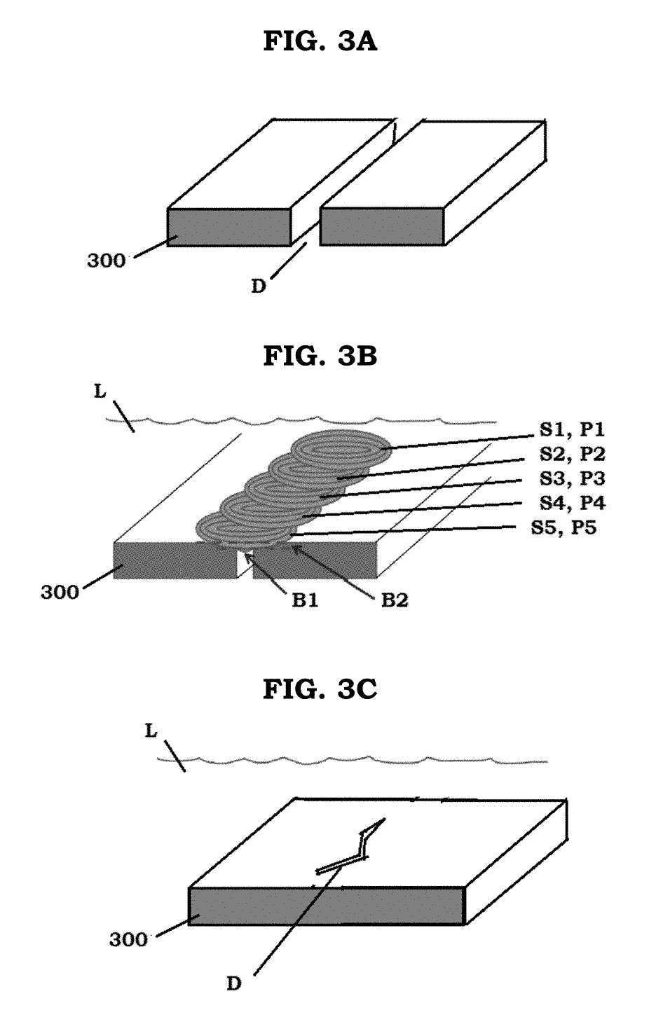

FIGS. 2A to 2B illustrate apparatuses for performing friction-spot sealing according to some example embodiments.

Referring to FIG. 2A, according to an example embodiment, an apparatus 200 for performing friction-spot sealing to reduce leakage through a defect area defined in a workpiece 300 is provided. The apparatus 200 may also be referred to as a machine. The workpiece 300 may be a reactor component such as any one of the internal reactor components (e.g., shroud, steam separator) in the reactor pressure vessel assembly 100 described in FIG. 1 of the present application. The apparatus 200 may also be used for performing friction-spot sealing on other workpiece structures, such as a ship hull, offshore drilling structure, nautical vessel, storage tank, and the like. However, example embodiments are not limited thereto.

The apparatus may include a controller 210, an input/output device 220 such as a keyboard and display, a securing structure 230, a platform 240, a motor 250, a consumable structure storage 285 for storing used and/or unused consumable structures 260, an instrument 270, a platform driver 280, and a coupling structure 290. The controller 210 may include a processor 212, a memory 214, and a power supply 216. The processor 212 may be embodied as hardware, such as a microcontroller, a central processing unit, and/or an application specific integrated circuit. The memory 214 may be a nonvolatile memory (e.g., flash memory) or a volatile memory (e.g., DRAM), or a combination thereof. The controller 210 may direct commands and power from the power supply 216 for controlling operations of various structures of the apparatus 200, such as the platform driver 280, motor 250, and instrument 270. The motor 250 may be a fluid-powered motor, pressure-powered motor, an AC-powered motor, or a DC-powered motor. The motor 250 may be configured to at least one of rotate and oscillate the consumable structure 260.

The controller 210 may control the instrument 270 to determine a location of defects in the defect area of the workpiece 300 and/or sizes of defects in the defect area. The instrument 270 may include a defect-inspection camera for identifying locations of the defects in the defect area and/or an ultrasonic sensor for identifying information related to the depths of defects in the defect area. The power supply 216 may be connected to the motor 250, platform driver 280, and controller 210.

The coupling structure 290 may couple the consumable structure 260 to the motor 250. The coupling structure 290 may connect the consumable structure 260 to the platform 240. The coupling structure 290 may be disengaged to unsecure the consumable structure 260 from the platform 240. The coupling structure 290 may operate in a manner that is the same as or similar to how a drill bit holder secures a drill bit and/or may be disengaged for removing a drill bit. When a consumable structure 260 is used up, the consumable structure 260 may be removed and the coupling structure 290 may secure a different consumable structure 260 that is new or at least is suitable for use. The coupling structure 290 may be embodied as a chuck or collet, but is not limited thereto.

The platform driver 280 may be configured to move platform 240 in different directions of an x-y-z or R-θ-Z Polar coordinate system. The platform driver 280 may raise and lower the platform 240 in a z-direction in order to press the consumable structure 260 against different locations of the workpiece 300 while the consumable structure 260 is at least one of rotating and oscillating. The platform driver 280 may retract the consumable structure 260 away from workpiece 300. Additionally, the platform driver 280 may move the platform 240 in the x-direction and y-direction to move consumable structure 260 to face different locations of the workpiece 300. The platform driver 280 may include a motor for adjusting the position of the platform 240. The platform driver 280 may retract, rotate, press, and/or reposition the consumable structure 260 on demand. For example, control commands may be provided based on a programmed routine and/or commands provided by the input/output device 220.

In some example embodiments, apparatus 200 may include a separate consumable driver (not shown) for pressing the consumable structure 260 against the workpiece 300 and/or retracting the consumable structure 260 from the workpiece, and the platform driver 280 may then be used to move the consumable driver to different locations and/or adjusting the position of the platform 240.

The controller 210 may be configured to control the motor 250, and the platform driver 280 to form a bridge including a plurality of spot material portions (e.g., S1, S2, S3) on the workpiece 300. The bridge may be formed without using a fusion welding process. As described later in more detail, each one of the plurality of spot material portions (e.g., S1, S2, S3) may overlap at least one other spot material portion among the plurality of spot material portions. The controller 210 may be configured to control the motor 250 and the platform driver 280 to form the plurality of spot material portions on the workpiece 300 (e.g., reactor component) by friction-sealing parts of the consumable structure 260 to different parts of the workpiece 300 (e.g., reactor component). The controller 210 may control the motor 250 and the platform driver 280 to form the plurality of spot material portions (e.g., S1, S2, S3) on the workpiece 300 in a pattern that overlaps the defect area or covers a region of the workpiece 300 that includes the defect area. At least one of the spot material portions (e.g., S1, S2, S3) may overlap a previously deposited spot material portion to progressively affect a final seal condition over the defect area or a region of the workpiece that includes the defect area.

Referring to FIG. 2B, according to an example embodiment, an apparatus 200′ for performing friction-spot sealing to reduce leakage through a defect area defined in a workpiece 300 is provided. The apparatus 200′ may include a controller 210, an input/output device 220, a motor 250, a consumable structure storage 285 for storing used and/or unused consumable structures 260, an instrument 270, and a coupling structure 290. The controller 210 may control the instrument 270 to determine a location of defects in the defect area of the workpiece 300 and/or sizes of defects in the defect area. The apparatus 200′ may also be referred to as a machine.

Unlike the apparatus 200 of FIG. 2A, the securing structure 230 in the apparatus 200′ may connect to a base structure 291 instead of the workpiece 300. The apparatus 200′ includes a robotic arm that includes a plurality of connecting members (e.g., 293 and 297) and a plurality of elongate members (e.g., 295 and 299). The robotic arm may also be referred to as a driver. The base structure 291 may rotate the securing structure 230 to adjust a position the robotic arm relative to the workpiece 300. The connecting members include a first connecting member 293 for raising and lowering a first elongate member 295 and a second connecting member 297 for raising and lowering a second elongate member 299. Each of the base 291, first connecting member 293, and second connecting member 297 may be embodied to include an actuator (e.g., servo or stepper motor) for rotating and moving the securing structure 230, first elongate member 295, and second elongate member 299, respectively. The power supply 216 in the controller 210 may be connected to the motor 250, robotic arm, processor 212, and memory 214.

The coupling structure 290 may couple the consumable structure 260 to the motor 250. The coupling structure 290 may connect the consumable structure 260 to the robotic arm, for example, the second elongate member 299. The coupling structure 290 may be disengaged to unsecure the consumable structure 260 to the robotic arm. The coupling structure 290 may be embodied as a chuck or collet, but is not limited thereto. The motor 250 and instrument 270 may be connected to the coupling structure 290. The motor 250 may be configured to at least one of rotate and oscillate the consumable structure 260.

The apparatus 200′ may be configured to move the coupling structure 290 in different directions of an x-y-z or R-θ-Z Polar coordinate system. When the consumable structure 260 is connected to the coupling structure 290, the apparatus 200′ may use the robotic arm to raise and lower the consumable structure 260 in a z-direction in order to press the consumable structure 260 against different locations of the workpiece 300 while the consumable structure 260 is at least one of rotating and oscillating. The apparatus 200′ may also use the robotic arm to retract the consumable structure 260 away from workpiece 300 and reposition the consumable structure 260 in the x-direction and/or y-direction to face different locations of the workpiece 300.

The controller 210 may be configured to control the motor 250, robotic arm, and base 291 to form a bridge including a plurality of spot material portions (e.g., S1, S2, S3) on the workpiece 300. The bridge may be formed without using a fusion welding process. The controller 210 may be configured to control the motor 250, robotic arm, and base 291 to form the plurality of spot material portions on the workpiece 300 (e.g., reactor component) by friction-sealing parts of the consumable structure 260 to different parts of the workpiece 300 (e.g., reactor component). The spot material portions (e.g., S1, S2, S3) may be formed on the workpiece 300 in a pattern that overlaps the defect area or covers a region of the workpiece 300 that includes the defect area.

FIGS. 2C to 2E illustrate rotational movement, rotational oscillation, and linear oscillation of a consumable structure using friction-spot sealing apparatuses according to some example embodiments.

Referring to FIG. 2C, in some example embodiments, either one of the above-described apparatuses 200 and 200′ may rotate that consumable structure 260 in a non-oscillatory manner (e.g., complete rotations in a same direction) using the motor 250. In this manner, either one of the apparatuses 200′ and 200′ may be used for friction-sealing a part (e.g., a first part) of the consumable structure 260 by pressing the consumable structure 260 against one or more positions (e.g., first position) of the workpiece 300 (e.g., reactor component) while using the motor 250 to rotate the consumable structure 260 in a non-oscillatory manner. Although FIG. 2C illustrates a counterclockwise rotation direction, the motor 250 may alternatively rotate the consumable structure 260 in a clockwise direction.

Referring to FIG. 2D, in some example embodiments, either one of the above-described apparatuses 200 and 200′ may rotate that consumable structure 260 in an oscillatory manner (e.g., partial rotations back and forth) using the motor 250. In this manner, either one of the apparatuses 200′ and 200′ may be used for friction-sealing a part (e.g., a first part) of the consumable structure 260 to form spot material portions (e.g., S1, S2, S3) by pressing the consumable structure 260 against one or more positions (e.g., first position) of the workpiece 300 (e.g., reactor component) while using the motor 250 to rotate the consumable structure 260 in an oscillatory manner. FIG. 2D illustrates an example where the consumable structure 260 is partially rotated in a clockwise and counterclockwise direction without undergoing a fully rotation. However, example embodiments are not limited thereto, and different oscillatory rotational patterns may be employed.

Referring to FIG. 2E, in some example embodiments, either one of the above-described apparatuses 200 and 200′ may adjust a position of the consumable structure 260 in an oscillatory manner (e.g., linear oscillations back and forth) using the motor 250. In this manner, either one of the apparatuses 200′ and 200′ may be used for friction-sealing a part (e.g., a first part) of the consumable structure 260 to form spot material portions (e.g., S1, S2, S3) by pressing the consumable structure 260 against one or more positions (e.g., first position) of the workpiece 300 (e.g., reactor component) while using the motor 250 to adjust a position of the consumable structure 260 in an oscillatory manner. FIG. 2E illustrates an example where the consumable structure 260 is moved back and forth in linear directions, such as left and right and/or up and down in FIG. 2E. However, example embodiments are not limited thereto, and different oscillatory linear oscillation directions may be employed to adjust the position of the consumable structure 260, such as diagonal directions.

FIGS. 2F and 2G illustrate adjusting a lateral tilt angle of consumable structure using friction-spot sealing apparatuses according to some example embodiments. Lead/lag angle tilts can also be used to benefit, including the control of the overlapping spot thickness.

Referring to FIGS. 2F and 2G, in some example embodiments, either one of the above-described apparatuses 200 and 200′ may tilt a direction that the consumable structure 260 faces the work piece 300 when forming spot material portions (e.g., S1 to S3). The direction of travel that the apparatuses 200 and 200′ move the consumable structure 260 between forming the spot material portions (e.g., S1 to S3) may be retained as parallel to a top surface of the workpiece 300. The consumable structure 260 may be tilted at an angle that is one of a lag angle and a lead angle.

In this manner, either one of the apparatuses 200′ and 200′ may be used for friction-sealing a part (e.g., a first part) of the consumable structure 260 to form spot material portions (e.g., S1, S2, S3) by pressing the consumable structure 260 against one or more positions (e.g., first position) of the workpiece 300 (e.g., reactor component) while using the motor 250 to rotate and/or oscillate the consumable structure 260 and tilting the consumable structure 260. In FIG. 2F, the angle θ1 that the consumable structure 260 is tilted may be in a range of 1° to 10° (and/or 2° to 60°) with respect to the workpiece 300. In FIG. 2G, the angle θ2 that the consumable structure 260 is tilted may be in a range of 1° to 10° (and/or 2° to 6°) with respect to the workpiece 300. Adjusting the tilt angle θ1 and θ2 of the consumable structure 260 may be used to adjust a thickness of the spot material portions (e.g., S1 to S3) formed by friction-sealing the consumable structure 260 to workpiece 300.

The coupling structure 290 may tilt the consumable structure 260. Alternatively, the second connecting member 297 in the apparatus 200′ may adjust the position of the second elongate member 299 so the consumable structure 260 is tilted at the angle θ1 in FIG. 2F or the angle θ2 in FIG. 2G with respect to the workpiece 300. Alternatively, the consumable structure 260 may be not tilted and may be perpendicular to the workpiece 300.

The workpiece 300 may be an internal reactor component (e.g., internal reactor component such as shroud or steam separator of a nuclear reactor assembly) of a nuclear reactor, the reactor component may include at least one of stainless steel (e.g., 308/L, 309/L, 312/L, 316/L, 321/L, 347/L, etc.), duplex steels, carbon steel, nickel-based alloys (52, 132, 182, 600, etc.), nickel-based steel, low-alloy steel, and chromium-based steel, but is not limited thereto. When the workpiece 300 is an internal reactor part of a nuclear reactor, the workpiece 300 may be a highly-irradiated part. A highly-irradiated part may have negligible helium (He) content of about 0 atomic weight percent before being used in a nuclear reactor, but may develop a helium (He) content of about 1 to about 3 atomic weight percent, or greater, after being used in the nuclear reactor. However, the workpiece 300 may be formed of other materials depending on the application of the workpiece 300. For example, in some example embodiments, the spot material portions may be applied through a friction-sealing process to malleable, thermally softening materials other than metals, such as thermoplastic composites and polymers.

The consumable structure 260 may include the same material as a material of the workpiece 300. Alternatively, the consumable structure 260 and the workpiece 300 may be formed of different or multiple materials, or the consumable structure 260 may include at least one material that is not included in the workpiece 300. The consumable structure 260 may have a rod or cylindrical shape and a diameter or width in a range of 1 mm to 25 mm, but is not limited thereto. A length of the consumable structure may be in a range from approximately 50 mm to 250 mm and/or in a range of 75 mm to 225 mm, but is not particularly limited.

The consumable structure 260 may include at least one metal and/or metal alloy. The metal and/or metal alloys may include at least one metal that is ductile at an elevated temperature below the melting point of the metal. Numerous base metal and metal alloys can be used for the consumable structure 260 as long as the material(s) of the consumable structure 260 is metallurgically compatible with the material(s) of the workpiece 300 in the hot, plasticized but solid state material phase during the friction-sealing a spot material portion. Friction-sealing a part of the consumable structure 260 onto the workpiece 300 to form a spot material portion on the workpiece 300 may be performed at a lower temperature than fusion welding the consumable structure 260 to the workpiece 300. This is because friction-sealing a part of the consumable structure 260 to the workpiece 300 does not require melting the consumable structure 260 or workpiece 300. In contrast, fusion welding relies on heating and melting two materials to join them together. Thus, with friction-sealing, metallurgical compatibility between the consumable structure and the workpiece is easier to achieve than for fusion welding where detrimental microstructures can form on cooling from the liquid state and lead to various kinds of hot cracking and solidification cracking when cooled.

The consumable structure 260 may further include at least one noble metal (e.g., Cu, Ru, Rh, Pd, Ag, Re, Os, Ir, Pt, Au, Hg). Noble metals, such as Pd or Pt and/or other noble metals, may reduce crack growth in the workpiece 300 from stress corrosion cracking (SCC). The addition of noble metals, such as Pd or Pt, to the consumable structure 260 may improve the resistance of a bridge formed from the consumable structure 260 to SCC. If the workpiece 300 is a nuclear reactor component, the radiolysis of water forms oxygen and hydrogen, which promote intergranular stress corrosion cracking (IGSCC). However, noble metals, such as Pd or Pt, provide resistance to SCC because noble metals act as a surface catalyst for more efficient recombination of hydrogen and oxygen (present from the radiolytic decomposition of the reactor coolant water). The consumable structure 260 may further include ferrite (and/or a composition that produces ferrite upon deposition) to increase hot cracking resistance and/or SCC resistance of spot material portions (e.g., S1 to S3) formed on the workpiece 300.

When the apparatus 200 (or apparatus 200) is used to form spot material portions (e.g., S1 to S3) by friction-sealing parts of the consumable structure 260 onto the workpiece 300 (e.g., reactor component), the consumable structure 260 may be rotated at a rotational speed (and/or oscillated at an oscillation frequency) and may contact the workpiece 300 for a period of time based on a material of interest and empirical study. For example, the consumable structure 260 may be rotated at about 500 to about 5000 rotations per minute (RPM) while the apparatus 200 (or apparatus 200′) presses the consumable structure 260 to contact the workpiece 300. A rotational speed of about 1000 to 4000 RPM may be used if the workpiece 300 is formed of austentitic stainless steel 300, or a similar material. The consumable structure 260 may contact the workpiece 300 for about 0.5 to about 10 seconds (or about 0.5 to about 5 seconds) when forming a spot material portion. In addition, or in the alternative, the consumable structure 260 may be oscillated at a frequency in a range of 1000 to 4000 Hz while the apparatus 200 (or apparatus 200) presses the consumable structure 260 to contact the workpiece 3000. The consumable structure 260 may contact the workpiece 300 for about 0.5 to about 10 seconds (or about 0.5 to about 5 seconds) when forming a spot material portion.

Forming a spot material portion by friction-sealing may include pressing the consumable structure 260 against a position of the workpiece 300 (e.g., reactor component) using a pressure, a contact time, a consumable diameter or width, and a motion speed of the consumable structure 260 that are sufficient to plasticize a part of the consumable structure 260 without heating the consumable structure 260 above a melting point of the workpiece 300. The motion speed may correspond to one of a rotational speed, a rotational oscillation frequency, and a linear oscillation frequency.

After the consumable structure 260 is pressed against the workpiece 300 for the contact time while at least one of rotating and oscillating the consumable structure, the consumable structure 260 may be moved away from the workpiece 300 to limit and/or prevent the consumable structure 260 from being permanently welded to the workpiece 300, and/or to control the thickness of an individual spot.

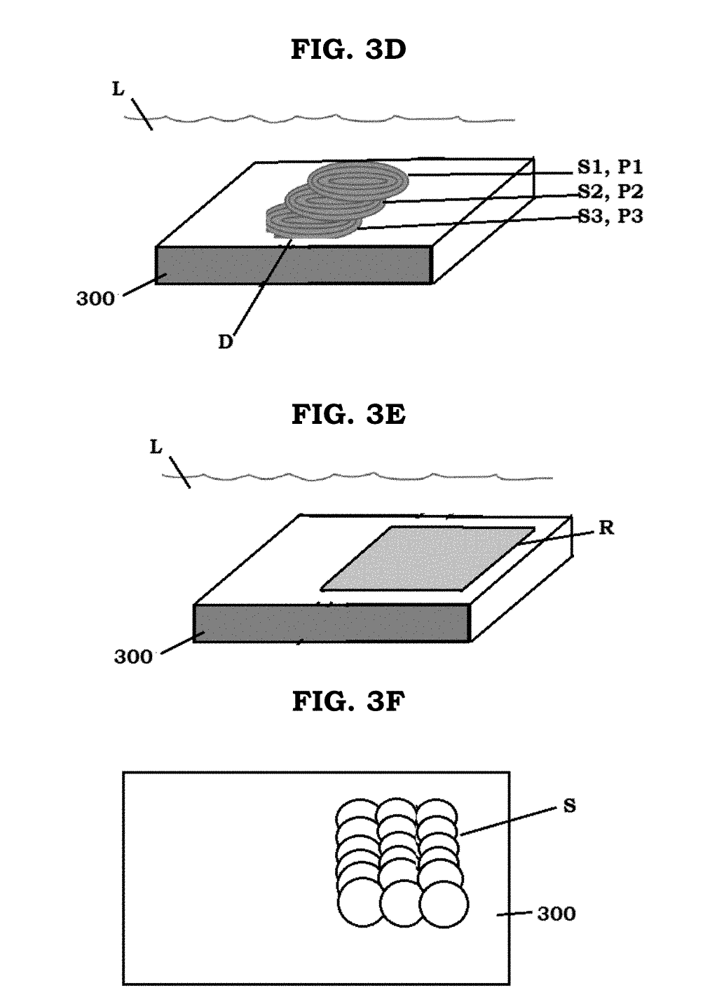

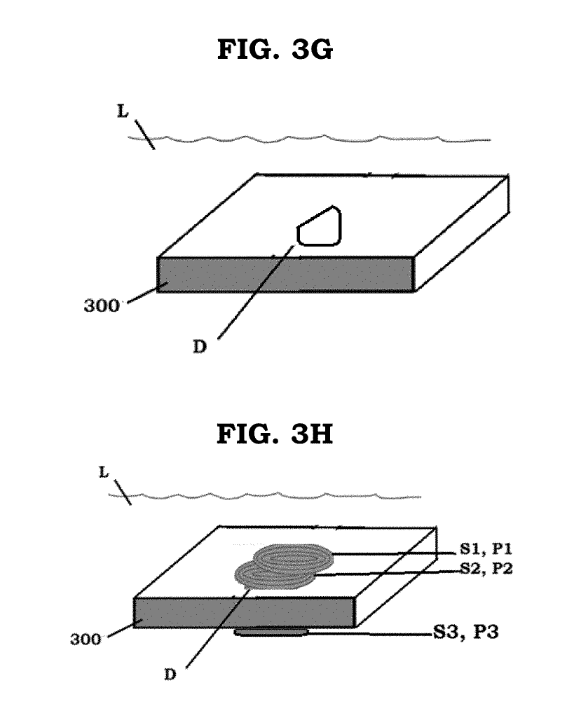

FIGS. 3A, 3C, 3E, and 3G illustrate a gap defect area, a crack defect area, a region including a defect area, and an opening defect area, respectively, in workpieces according to some example embodiments. FIGS. 3B, 3D, 3F, 3H illustrate the workpieces in FIGS. 3A, 3C, 3E, and 3G, respectively, after being treated using various friction-spot sealing methods according to some example embodiments.

Referring to FIGS. 3A and 3B, FIG. 3A illustrates an example where the defect area D is a gap in the workpiece 300 and FIG. 3B illustrates the workpiece 300 after being treated using a friction-spot sealing method according to some example embodiments. As illustrated in FIG. 3B, the workpiece 300 may be submerged in a liquid L such as water or a water-steam mixture. Locally dry environments may also be temporarily created in the sealing zone. In some example embodiments, leakage through the defect area D may be reduced, and/or the growth of the defect area D may be limited, by forming a bridge that includes plurality of spot material portions (e.g., S1 to S5) bonded to a plurality of positions (e.g., P1 to P5) of the workpiece 300. The apparatus 200 (or apparatus 200) described above may be used with a consumable structure 260 to form the bridge using a friction-spot sealing method. FIG. 3B illustrates some excess bridge material B1 may extend into the gap that is the defect area D and other bridge material B2 may be bonded to the workpiece 300.

The forming the plurality of spot material portions may include forming a first spot material portion S1 on the workpiece 300 by moving the consumable structure 260 to contact a first position P1 of the workpiece 300 for a first period of time while applying a first axial force to the consumable structure and using the apparatus 200 (or apparatus 200) to at least one of rotate the consumable structure 260 at a first rotational speed and oscillate the consumable structure 260 at a first frequency so a first part of the consumable structure 260 bonds to the first position P1 of the workpiece while the first position P1 of the workpiece 300 is at least partially submerged under the liquid L, moving a remaining portion of the consumable structure 260 away from the first position P1 of the workpiece 300 to face a second position P2 of the workpiece 300, forming a second spot material portion S2 on the workpiece 300 by moving the remaining portion of the consumable structure 260 to contact the second position P2 of the workpiece 300 for a second period of time while applying a second axial force to the remaining portion of the consumable structure 260 and using the apparatus 200 (or apparatus 200) to at least one of rotate the remaining portion of the consumable structure 260 at a second rotational speed and oscillate the consumable structure 260 at a second frequency so a second part of the consumable structure 260 bonds to the second position of the workpiece 300 while the second position P2 is at least partially submerged under the liquid L. After forming a spot material portion (e.g., first spot material portion S1), the consumable structure 260 may be retracted from a surface of the workpiece 300 to terminate a spot seal before the consumable structure 260 is moved to a different location to form the next spot material portion (e.g., second spot material portion S2). The first and second positions P1 and P2 of the workpiece 300 are different positions and include a portion of the defect area D such that at least one of the first and second spot material portions P1 and P2 overlaps at least part of the defect area D. In some example embodiments, the first and second positions P1 and P2 may correspond to different portions of the defect area D. The third to fifth spot material portions S3 to S5 may be formed using the same friction-sealing method on the third to fifth positions P3 to P5 of the workpiece 300.

Although FIG. 3A illustrates an example where the bridge includes a line pattern of five spot material portions S1 to S5, example embodiments are not limited thereto. For example, a pattern including more or fewer than 5 spot material portions may be formed. Also, the pattern may include multiple columns of spot material portions. Additionally, although the defect area in FIG. 3A is a gap with a linear pattern and substantially uniform width, one of ordinary skill in the art would recognize that the bridge of spot material portions may be formed on a defect area having a different shape and/or variable width.

Referring to FIGS. 3C and 3D, FIG. 3C illustrates an example where the defect area D is a crack in the workpiece 300 and FIG. 3D illustrates the workpiece 300 after being treated using various friction-spot sealing methods according to some example embodiments. The crack may have a depth that is less than the thickness of the workpiece 300, or the crack may extend through an entire thickness in at least part of the workpiece 300. The workpiece 300 may be submerged in a liquid L. In some example embodiments, leakage through the defect area D may be reduced, and/or the growth of the defect area D may be limited, by forming a bridge that includes plurality of spot material portions (e.g., S1 to S3) bonded to a plurality of positions (e.g., P1 to P3) of the workpiece 300. The apparatus 200 (or apparatus 200) described above may be used with a consumable structure 260 to form the bridge using a friction-spot sealing method.

Although FIG. 3D illustrates an example where the bridge includes a line pattern of three spot material portions S1 to S3, example embodiments are not limited thereto. For example, a pattern including more or fewer than 3 spot material portions may be formed. Also, the pattern may include multiple columns of spot material portions. Additionally, one of ordinary skill in the art would recognize that the bridge of spot material portions may be formed on a defect area having a different shape and/or variable width.

Referring to FIGS. 3E and 3F, FIG. 3E illustrates an example where the workpiece 300 includes a region R that includes the defect area. The region R may include a greater number of defects (or greater defect density) than a different location of the workpiece 300 outside of region. FIG. 3F illustrates the workpiece 300 after being treated using various friction-spot sealing methods according to some example embodiments. The workpiece 300 may be submerged in a liquid L. Leakage through the defect area D may be reduced, and/or the growth of the region R may be limited, by forming a bridge that includes plurality of spot material portions S bonded to a plurality of positions of the workpiece 300. The apparatus 200 (or apparatus 200) described above may be used with a consumable structure 260 to form the bridge using a friction-spot sealing method.

Although FIG. 3F illustrates an example where the bridge includes a pattern with five rows and three columns of spot material portions S, example embodiments are not limited thereto and the pattern may be varied. Additionally, one of ordinary skill in the art would recognize that the bridge of spot material portions may be formed on a region having a different shape and/or dimension than the example shown in FIG. 3E.

Referring to FIGS. 3G and 3H, FIG. 3G illustrates an example where the defect area D is an opening defect area (e.g., hole) in the workpiece 300. FIG. 3F illustrates the workpiece 300 after being treated using various friction-spot sealing methods according to some example embodiments. The workpiece 300 may be submerged in a liquid L. Leakage through the defect area D may be reduced, and/or the growth of the region R may be limited, by forming a bridge that includes plurality of spot material portions S bonded to a plurality of positions of the workpiece 300. As shown in FIG. 3H, a first bridge including a plurality of spot material portions S1 and S2 may be formed on a plurality of positions P1 and P2 on a top surface of the workpiece 300 and a second bridge including a spot material portion may be formed on a corresponding position P3 at a bottom surface of the workpiece 300. The apparatus 200 (or apparatus 200) described above may be used with a consumable structure 260 to form the bridge using a friction-spot sealing method.

Although FIG. 3F illustrates an example where the first bridge includes two spot material portions S1 and S2 and the second bridge includes a spot material portion S3, example embodiments are not limited thereto and the pattern of the first bridge and/or the pattern of the second bridge may varied to include more or fewer spot material portions. Additionally, one of ordinary skill in the art would recognize that the bridge of spot material portions may be formed on a region having a different shape and/or dimension than the example shown in FIG. 3H.

A thickness of the spot material portions (e.g., S1 and/or S), described above in FIGS. 2A, 2B, 3B, 3D, 3F, and/or 3H may be in a range of 0.1 mm to 10 mm (and/or 1.0 to 6.0 mm). A width of the spot material portions (e.g., S1 and/or S) may be in a range of 0.1 mm to 250 mm (and/or 1 mm to 10 mm). However, example embodiments are not limited thereto and the thickness and widths of the spot material portions may vary.

Referring to FIGS. 3A to 3H, a friction-sealing method according to some example embodiments may be used to form a product that includes a workpiece 300 defining a defect area D (see FIGS. 3A, 3E, and 3F) and a bridge bonded to the workpiece at the defect area. The bridge may include a plurality of spot material portions (e.g., S1 to S3 in FIG. 3D). Each one of the plurality of spot material portions may overlap at least one other spot material portion among the plurality of spot material portions. The workpiece 300 may be a reactor component of a nuclear reactor assembly, such as one of the internal reactor components of the nuclear reactor pressure vessel assembly described in FIG. 1 of the present application.

As shown in FIGS. 3A, 3C, and 3G, the defect area D may include one of a gap, a crack, and an opening defined in the workpiece. The plurality of spot material portions may form a pattern (or bridge) that overlaps the defect area. A width and a length of the pattern (or bridge) may be greater than a width and a length of the defect area. As shown in FIG. 3E, the defect area may be in a region R of the workpiece 300 that is smaller than an overall size of the workpiece. The plurality of spot material portions in the bridge may form a pattern that covers the region of the workpiece.

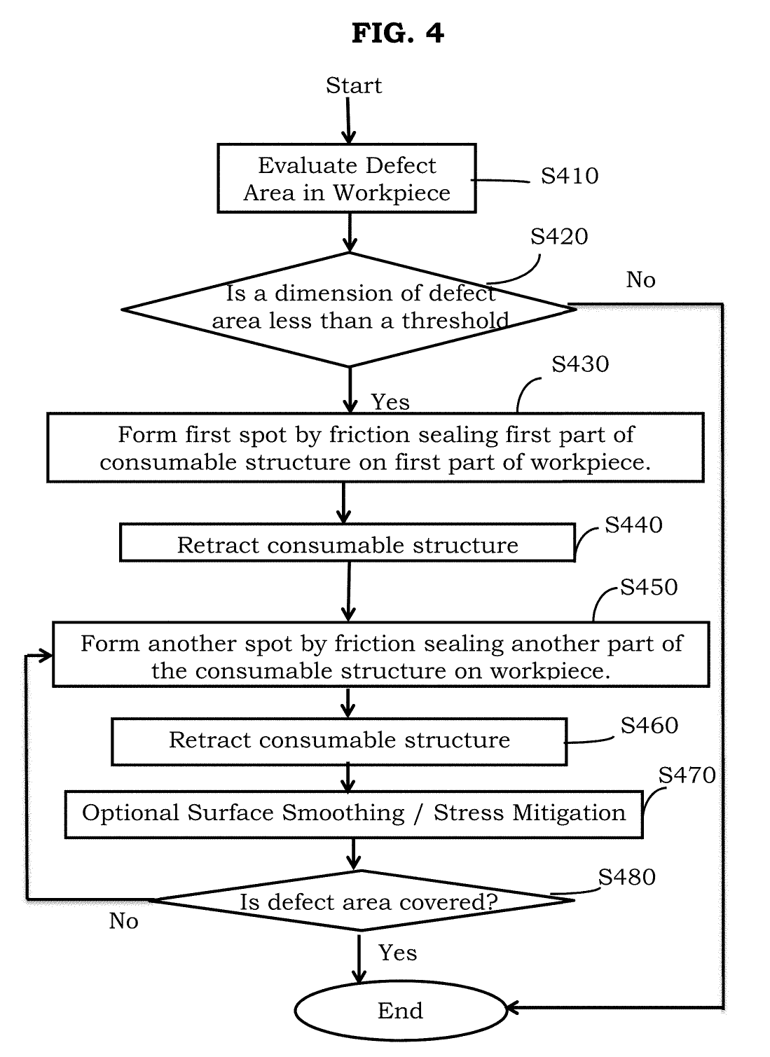

FIG. 4 is a flow chart illustrating operations of a friction-spot sealing method according to an example embodiment. The friction-spot sealing method may be performed for reducing leakage through a defect area defined in a workpiece. The workpiece may be a reactor component such as a shroud, or a steam separator, but is not limited thereto and may be other reactor components or other structures that are not reactor components.

Referring to FIG. 4, in operation S410, a workpiece may be examined visually or examined with the aid of an instrument such as a camera and/or ultra-sonic testing equipment to evaluate whether workpiece includes a defect area. Operation S410 may be performed using the instrument 270 of the apparatus 200 (or apparatus 200) described in FIGS. 2A and 2B, or using a separate instrument apart from the apparatus 200 (or apparatus 200). If the workpiece includes a defect area, in operation S420, a dimension of the defect area such as a size (e.g., width, length, diameter) and/or a thickness of the defect area may be compared to a threshold value. The processor 212 of the controller 210 in the apparatus 200 in FIG. 2A (or apparatus 200′ in FIG. 2B) may be configured to compare the dimension of the defect area to the threshold value. If the dimension of the defect area is greater than or equal to the threshold value, then a friction-spot sealing method may not be used to form a bridge over the defect area.

If the dimension of the defect area is less than the threshold value, then a friction-spot sealing method according to an example embodiment may be used to form a bridge including a plurality of spot material portions on the workpiece over at least part of the defect area. The forming a bridge over at least part of the defect area may be performed without using a fusion welding process and may be performed while the workpiece including the defect area is underwater.

In operation S430, the forming the bridge may include forming a first spot material portion on the workpiece by friction-sealing a first part of a consumable structure to the workpiece at a first position of the workpiece. The friction-sealing the first part may include pressing the consumable structure against the first position of the workpiece while using a machine to at least one of rotate and oscillate the consumable structure. The consumable structure may be coupled to a machine that includes a motor before forming the first spot material portion, and the motor may be used to at least one of rotate and oscillate the consumable structure while the first spot material portion is formed.

In operation S440, the machine may be used to move the consumable structure away from the workpiece to face a second position of the workpiece. In operation S450, the forming the bridge may include forming a second spot material portion on the workpiece by friction-sealing a second part of the consumable structure to the workpiece to the second position. The friction-sealing the second part of the consumable structure may include pressing the consumable structure against the second position of the workpiece while using the machine to at least one of rotate and oscillate the consumable structure.

The first and second positions of the workpiece may be different positions and include a portion of the defect area such that at least one of the first and second spot material portions overlaps the portion of the defect area. Next, in operation S460, the consumable structure may be retracted from the workpiece using the machine. In operation S470, an optional surface smoothing and/or stress mitigation process may be performed on the bridge including the first and second spot material portions formed on the workpiece. The surface smoothing and/or stress mitigation process may include improving a surface finish of the spot material portions in the bridge using one of a, a sanding process, an abrasive brushing process and a surface-treatment process. Operation S470 may be performed using General Electric's ReNew™ Surface Improvement process. The ReNew™ Surface Improvement process mechanically conditions metals at weld areas to reduce the formation and/or growth of small cracks due to tensile surface stresses and/or stress corrosion cracking.

In operation S480, the workpiece may be examined to check if the bridge formed in operations S430 to S450 covers the defect area of the workpiece. If the defect area is covered by the bridge including the spot material portions, then the friction-sealing process may be complete. However, if the workpiece includes another defect area, then the friction-sealing process may be performed to cover the other defect area.

On the other hand, if the bridge does not fully cover the defect area of the workpiece, then operations S450 and S460 may be repeated to form another spot material portion on the workpiece by friction-sealing another part of the consumable structure to the workpiece at another position that is different than the first and second positions of the workpiece. The friction-sealing the other part of the consumable structure may including pressing the consumable structure against the other position of the workpiece while using the machine to at least one of rotate and oscillate the consumable structure. Then, in operations S460, S470, and S480 may be repeated. In operation S480, the workpiece may be examined to check if the bridge formed in operations S430 to S450 covers the defect area of the workpiece. If the defect area is covered by the bridge including the spot material portions, then the friction-sealing process may be complete. However, if the workpiece includes another defect area, then the friction-sealing process may be performed to cover the other defect area.

If the bridge does not fully cover the defect area of the workpiece, then operations S450 to S480 may be repeated in a loop as many times as are necessary to form a bridge that covers the defect area. Either one of the apparatuses 200 and 200′ described with reference to FIGS. 2A to 2G may be used as the machine for performing operations S430, S440, S450, and S460. However, example embodiments are not limited thereto. One of ordinary skill in the art would appreciate that the method described with reference to FIG. 4 of the present application may be performed using various types of machines.

For example, a diver or remote tooling technician could use a separate inspection instrument such as a camera to perform operations S410, and S420, a drill-like machine (e.g., a machine including a motor for rotating and/or oscillating the consumable structure, power circuitry for powering motor, control logic, and a chuck or collet for securing the consumable structure) to perform operations S430 to S460 using the drill-like machine, and an abrasive object such as a brush for performing operation S470. Using a drill-like machine as the machine, the diver could couple the consumable structure to the drill-like machine using the chuck or collet, at least one of rotate and oscillate the consumable structure using the motor, and form a plurality of spot material portions bonded a plurality of positions of the workpiece. The plurality of spot material portions may be formed by manually pressing the consumable structure against different locations of the workpiece while the drill-like machine is used to at least one of rotate and oscillate the consumable structure.

In an example embodiment, operations S410 and S420 of FIG. 4 may be modified by using the instrument 270 on the apparatus 200 in FIG. 2A, instrument in apparatus in FIG. 2B, or a separate inspection instrument such as a camera operated by a diver or remote tooling technician, to map locations of a plurality of defects in a defect area of a workpiece, and select defects among the plurality of defects based on at least one dimension of the plurality of defects. Then, bridges may be formed over the selected defects without using a fusion welding process. The bridges may be formed by forming a plurality of spot material portions on the workpiece by friction-sealing parts of the consumable structure to different parts of the reactor component while using a machine to position and at least one of rotate and oscillate the consumable structure, retracting the consumable structure from the reactor component after forming each corresponding one of the plurality of spot material portions, and repositioning the consumable structure to contact a different part of the workpiece before forming each next corresponding spot material portion among the plurality of spot material portions. The forming the bridge may include forming a first spot material portion and forming a second spot material portion. The forming the bridges may include forming spot material portion patterns that overlap the selected defects, and the spot material portion patterns may include the plurality of spot material portions.

As shown in FIGS. 3A, 3C, 3E, and 3G, the defect area inspected in operation S420 of FIG. 4 may be one of a crack, an opening, and a gap defined in the workpiece, or a region in the workpiece that includes a relatively higher number of defects than an area outside of the region in the workpiece. A bridge may be formed over at least part of the defect area. The bridge may be formed without using a fusion welding process and may be formed while the workpiece including the defect area is underwater. The workpiece may be a reactor component. Referring to FIGS. 2A, 2B, 3B, 3D, 3F, and 3H, the bridge may be formed by forming a plurality of spot material portions on the workpiece by friction-sealing parts of the consumable structure on different parts of the workpiece along the defect area D while using the machine (e.g., apparatus 200 in FIG. 2A or apparatus 200′ in FIG. 2B) to position and at least one of rotate and oscillate the consumable structure 260. Each of the plurality of spot material portions may overlap another one of the plurality of spot material portions in a pattern that overlaps the defect area D. The forming the bridge may include forming a first spot material portion and forming a second spot material portion on the workpiece.

A width and a length of the pattern (or bridge) formed over at least part of the defect area may be greater than a width and a length of the defect area. For example, as shown in FIG. 3B, the bridge including spot material portions S1 to S5 has a width and a length that is greater than the defect area D in FIG. 3A. Referring to operations S430 to S450 of FIG. 4, forming the bridge may include moving the consumable structure away from contacting the workpiece after forming one of the plurality of spot material portions and repositioning the consumable structure to contact a different part of the workpiece before forming a next spot material portion among the plurality of spot material portions. As shown in FIG. 3B, for example, each of the plurality of spot material portions S1 to S5 may overlap another one of the plurality of spot material portions S1 to S5 in a pattern that overlaps the defect area D. Alternatively, if the bridge is formed over a region that includes the defect area, such as the region R and bridge including spot material portions S in FIGS. 3E and 3F, each one of the plurality of spot material portions S may partially overlap at least one other spot material portion among the plurality of spot material portions S to form a bridge (or pattern) that corresponds to the region R of the workpiece 300.

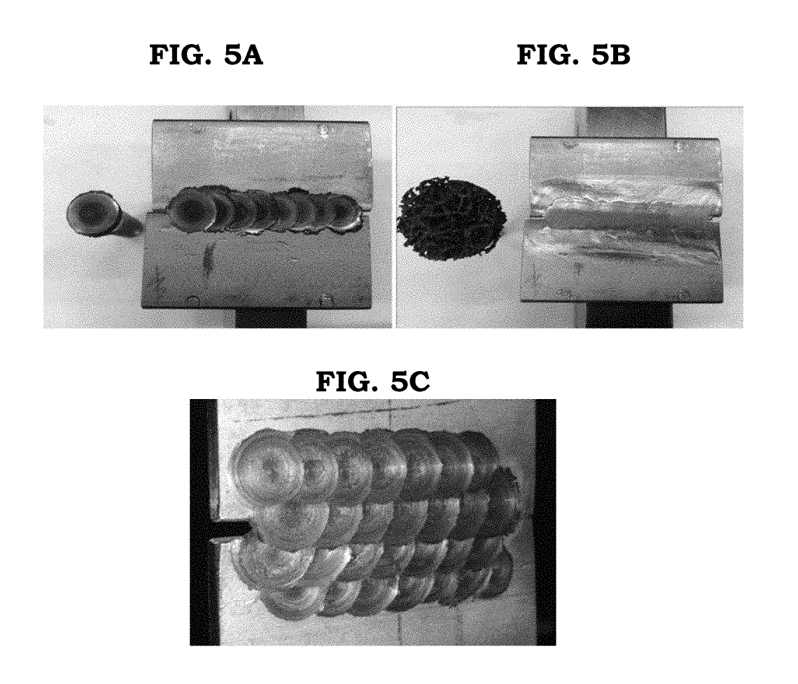

FIGS. 5A and 5C are examples of spot material portion patterns formed using friction-sealing methods according to some example embodiments. FIG. 5B illustrates the workpiece including the spot material portion pattern in FIG. 5A after a wet polishing process was performed.

Referring to FIG. 5A, a milling machine was used to friction-seal a spot material portion pattern on two stainless steel plates to join and seal the two stainless steel plates together. The milling machine rotated a 0.375 inch diameter (9.53 mm) stainless steel rod as consumable structure to form the spot material portions on the stainless steel plates. The stainless steel plates were separated by a tapered gap ranging from 0 to 3 mm to mimic a workpiece including a gap defect. The plates were 0.25 inches thick (6.35 mm). The spot material portion pattern was formed while the two stainless steel plates were submerged under water.

FIG. 5B illustrates the workpiece including the spot material portion pattern in FIG. 5A after a wet polishing process was performed. The wet polishing process provided a visual verification of the continuity of the seal, and surface smoothing and/or stress mitigation to the spot material portion pattern joining the two stainless steel plates.

Referring to FIG. 5C, a milling machine was used to friction-seal a spot material portion pattern on two stainless steel plates to join the two stainless steel plates together. The milling machine rotated a 0.375 inch diameter (9.53 mm) stainless steel rod as consumable structure to form the spot material portions on the stainless steel plates. The stainless steel plates were separated by a tapered gap ranging from 0 to 3 mm to mimic a workpiece including a gap defect. The plates were 0.25 inches thick (6.35 mm). The spot material portion pattern was formed while the two stainless steel plates were submerged under water. Unlike the spot material portion pattern in FIG. 5A, which is a single linear column, the spot material portion pattern in FIG. 5C includes four columns.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

1. A method for reducing leakage through a defect area defined in a reactor component, the method comprising:
forming a first spot material portion on the reactor component by friction-sealing a first part of a consumable structure to the reactor component at a first position of the reactor component, the friction-sealing the first part including pressing the consumable structure against the first position of the reactor component while using a machine to at least one of rotate and oscillate the consumable structure;
moving the consumable structure away from the reactor component to face a second position of the reactor component; and
forming a second spot material portion on the reactor component by friction-sealing a second part of the consumable structure to the reactor component at the second position of the reactor component, the friction-sealing the second part including pressing the consumable structure against the second position of the reactor component while using the machine to at least one of rotate and oscillate the consumable structure,
the first and second positions of the reactor component being different positions and including a portion of the defect area such that at least one of the first and second spot material portions overlaps the portion of the defect area.

2. The method of claim 1, wherein the friction-sealing the first part includes pressing the consumable structure against the first position of the reactor component while using the machine to rotate the consumable structure in a non-oscillatory manner.

3. The method of claim 1, wherein the friction-sealing the first part includes pressing the consumable structure against the first position of the reactor component while using the machine to oscillate the consumable structure in one of a linear and a rotational manner.

4. The method of claim 1, wherein
the reactor component includes at least one of stainless steel, carbon steel, nickel-based steel, low-alloy steel, and chromium-based steel,
a thickness of the first spot material portion is in a range of 0.1 mm to 6.0 mm, and
a width of the first spot material portion is in a range of 1 mm to 25 mm.

5. The method of claim 1, wherein
the consumable structure includes at least one metal,
the forming the first spot material portion by friction-sealing includes pressing the consumable structure against the first position of the reactor component using a pressure, a contact time, and a motion speed of the consumable structure that are sufficient to plasticize the first part of the consumable structure without heating the reactor component above a melting point of the reactor component, and
the motion speed corresponds to one of a rotational speed, a rotational oscillation frequency, and a linear oscillation frequency.

6. The method of claim 5, wherein
the consumable structure includes a same material as the reactor component,
the consumable structure has a rod shape, and
a diameter of the consumable structure is a range from 1 mm to 25 mm.

7. The method of claim 5, wherein
the consumable structure has a rod shape, and
the consumable structure includes at least one noble metal.

8. The method of claim 1, wherein
at least one of the forming the first spot material portion and the second spot material portion is performed while the reactor component is underwater,
the reactor component is an internal reactor component for use inside the reactor,
the reactor component has been highly irradiated, and
the reactor is a nuclear reactor.

9. The method of claim 8, wherein the reactor component is a shroud.

10. The method of claim 8, wherein the reactor component is a steam separator.

11. The method of claim 1, further comprising:
forming a bridge over at least part of the defect area without using a fusion welding process, wherein
the defect area is one of a crack, an opening, and a gap defined in the reactor component,
the forming the bridge includes forming a plurality of spot material portions on the reactor component by friction-sealing parts of the consumable structure on different parts of the reactor component along the defect area while using the machine to position and at least one of rotate and oscillate the consumable structure,
each of the plurality of spot material portions overlaps another one of the plurality of spot material portions in a pattern that overlaps the defect area, and
the forming the bridge includes the forming a first spot material portion and the forming a second spot material portion.

12. The method of claim 11, wherein
the forming the bridge includes forming the bridge to have a width and a length that are greater than a width and a length of the defect area such that at least one of the plurality of spot material portions bonds to locations of the reactor component that are adjacent to the defect area, and
the forming the bridge includes moving the consumable structure away from contacting the reactor component after forming one of the plurality of spot material portions and repositioning the consumable structure to contact a different part of the reactor component before forming a next spot material portion among the plurality of spot material portions.

13. The method of claim 1, further comprising:
forming a bridge over a region of the reactor component without using a fusion welding process, wherein
the region of the reactor component includes the defect area,
the forming the bridge includes forming a plurality of spot material portions on the reactor component by friction-sealing parts of the consumable structure to different parts of the region of the reactor component while using the machine to position and at least one of rotate and oscillator the consumable structure,
each one of the plurality of spot material portions partially overlaps at least one other spot material portion among the plurality of spot material portions to form a pattern that corresponds to the region of the reactor component, and
the forming the bridge includes the forming a first spot material portion and the forming a second spot material portion.

14. The method of claim 13, wherein the forming the bridge includes moving the consumable structure away from contacting the reactor component after forming one of the plurality of spot material portions and repositioning the consumable structure to contact a different part of the reactor component before forming a next spot material portion among the plurality of spot material portions.

15. The method of claim 1, further comprising:
coupling the consumable structure to the machine before the forming a first spot material portion, wherein
the machine includes a motor.

16. The method of claim 1, further comprising:
mapping locations of a plurality of defects in the defect area using an instrument;
selecting defects among the plurality of defects based on at least one dimension of the plurality of defects;
forming bridges over the selected defects without using a fusion welding process, wherein
the forming the bridges includes forming a plurality of spot material portions on the reactor component by friction-sealing parts of the consumable structure to different parts of the reactor component while using the machine to position and at least one of rotate and oscillate the consumable structure,
the forming the bridges includes retracting the consumable structure from the reactor component after forming each corresponding one of the plurality of spot material portions and repositioning the consumable structure to contact a different part of the reactor component before forming each next corresponding spot material portion among the plurality of spot material portions,
the forming the bridges includes the forming a first spot material portion and the forming a second spot material portion,
the forming the bridges includes forming spot material portion patterns that overlap the selected defects, and
the spot material portion patterns include the plurality of spot material portions.

17. An apparatus for reducing leakage through a defect area defined in a reactor component, comprising:
a motor configured to at least one of rotate and oscillate a consumable structure including at least one metal;
a coupling structure configured to couple the consumable structure to the motor;
a driver configured to press the consumable structure against different locations of the reactor component while the consumable structure is at least one of rotating and oscillating, the driver being configured to retract the consumable structure away from reactor component and to reposition the consumable structure to face the different locations of the reactor component; and
a controller configured to control the motor, and the driver to form a bridge including a plurality of spot material portions on the reactor component without using a fusion welding process, each one of the plurality of spot material portions overlapping at least one other spot material portion among the plurality of spot material portions.

18. The apparatus of claim 17, wherein
the controller is configured to control the motor and the driver to form the plurality of spot material portions on the reactor component by friction-sealing parts of the consumable structure to different parts of the reactor component, and
the controller is configured to control the motor and the driver to form the plurality of spot material portions on the reactor component in a pattern that overlaps the defect area or covers a region of the reactor component that includes the defect area.

19. The apparatus of claim 18, further comprising:
an instrument for determining at least one of locations of defects in the defects area and sizes of defects in the defect area; and
a power supply connected to the motor, driver, and controller.

20. A product, comprising:
a workpiece defining a defect area;
a bridge bonded to the workpiece at the defect area, the bridge including a plurality of spot material portions, each one of the plurality of spot material portions overlapping at least one other spot material portion among the plurality of spot material portions.

21. The product of claim 20, wherein
the workpiece is a reactor component of a nuclear reactor assembly,
the defect area is one of a crack, an opening, and a gap defined in the reactor component,
the plurality of spot material portions each include at least one metal.

22. The product of claim 21, wherein
the plurality of spot material portions form a pattern that overlaps the defect area, and
a width and length of the bridge is greater than a width and a length of the defect area.

23. The product of claim 20, wherein
the workpiece is a reactor component of a nuclear reactor assembly,
the defect area is in a region of the reactor component that is smaller than an overall size of the reactor component,
the plurality of spot material portions in the bridge form a pattern that covers the region of the reactor component.

24. A friction-spot bonding method for reducing leakage through a defect area defined in a workpiece, the method comprising:
using a machine that is coupled to a consumable structure to at least one of rotate and oscillate the consumable structure; and
forming a plurality of spot material portions bonded to a plurality of positions of the workpiece, the forming the plurality of spot material portions including,
forming a first spot material portion on the workpiece by moving the consumable structure to contact a first position of the workpiece for a first period of time while applying a first axial force to the consumable structure and using the machine to at least one of rotate the consumable structure at a first rotational speed and oscillate the consumable structure at a first frequency so a first part of the consumable structure bonds to the first position of the workpiece,
moving a remaining portion of the consumable structure away from the first position of the workpiece to face a second position of the workpiece,
forming a second spot material portion on the workpiece by moving the remaining portion of the consumable structure to contact the second position of the workpiece for a second period of time while applying a second axial force to the remaining portion of the consumable structure and using the machine to at least one of rotate the remaining portion of the consumable structure at a second rotational speed and oscillate the consumable structure at a second frequency so a second part of the consumable structure bonds to the second position of the workpiece,
the first and second positions of the workpiece being different positions and including a portion of the defect area such that at least one of the first and second spot material portions overlaps at least part of the defect area.

25. The method of claim 24, wherein
the consumable structure has a composition that will produce Ferrite phase upon deposition by friction, and
the forming the plurality of spot material portions is performed while the workpiece is at least partially submerged under a liquid.

26. The method of claim 24, further comprising:
performing a stress mitigation process on the plurality of spot material portions after the forming the plurality of spot material portions bonded to the plurality of positions of the workpiece, wherein
the forming the plurality of spot material portions includes covering the defect area with the plurality of spot material portions, and
the stress mitigation process includes improving a surface finish of the plurality of spot material portions using one of a sanding, and a surface-treatment process.

27. The method of claim 24, wherein
the forming the plurality of spot material portions includes tilting the consumable structure to contact at least one of plurality of positions of the workpiece at an angle while forming one of the plurality of spot material portions,
the angle is one of a lag angle and a lead angle, and
the angle is in a range of 1 to 10 degrees with respect to the workpiece.
